(19) United States
(12) Patent Application Publication
(10) Pub. No.: US 2007/0050270 A1
(43) Pub. Date: Mar. 1, 2007

(54) Methods for promoting entities through the sale of popular items

(76) Inventor: Matthew A. Morgan, Seattle, WA (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 11/214,880

(22) Filed: Aug. 31, 2005

(51) Int. Cl. G06F 17/30

(52) U.S. Cl. 705/27; 705/26

(57) ABSTRACT

Disclosed herein are methods of promoting particular entities comprising creating a directory of entities and promoting the entities within the directory. The entity creating the directory promotes the entities within the directory by (i) offering items for sale, wherein each item for sale is marked with an identifier of an entity within the directory, and (ii) providing information about an entity in the directory when a consumer expresses interest in an item offered for sale that is marked with the particular entity's identifier.

### FIELD OF THE INVENTION

The present invention relates to efficient and cost-effective methods for entities to promote themselves. More specifically, the invention relates to efficient and cost-effective methods for entities to promote themselves through the sale of popular items.

### BACKGROUND OF THE INVENTION

In order to succeed at whatever objective an entity has been organized to achieve, the entity generally must be able to promote its products, ideas and/or services. This promotion often occurs through marketing of an entity's products, ideas and/or services to the general public or to other entities. While promotion of products, ideas and/or services is often key to the success of an organized entity, resources to pursue promotional activities are often in short supply. While this problem is generally a concern for all entities, it can be especially problematic in the case of small or nonprofit entities.

Small entities, such as small businesses, are one type of entity that may lack the necessary resources to promote themselves to draw the attention of large markets. One approach that small entities have employed to market their products, ideas and/or services is to come together into co-ops, such as farmers markets, flea markets and the like (hereinafter “co-ops”), to market and sell at a collective time and place. The presence of many smaller entities present at a particular time and place draws a larger crowd to the area than would arrive if a single smaller entity was present. An additional method that smaller entities have used to promote themselves is by selling or advertising products, ideas and/or services over the internet.

While the above-described methods used by smaller entities may be effective for some, there are many smaller entities that are less able to take advantage of these marketing options. For instance, many entities rely on consumers visiting the particular location of the entity to appreciate the fullest scope of what the entity has to offer. In this situation, selling products at a co-op or over the internet is not as valuable to the entity because it does not necessarily drive consumers to the particular location of the entity.

One solution for entities whose location is an aspect of what the entity offers is to simply advertise at a co-op or over the internet rather than selling a product through these avenues. However, to attract consumers to read the information, the consumer must often be seeking information regarding the particular entity or business in which it is engaged in the first place. For instance, a destination hotel could post information about the services it offers on the internet, and a person seeking a hotel in the area where this hotel is found may seek out and find the information. A person not looking for hotels in the area, however, likely would not see the information. Likewise, if this same hotel set up a booth at a co-op to advertise and disseminate information, it is likely that only those consumers in attendance considering travel would stop at the booth. While some entities in this situation have adopted strategies such as giving away trinkets or sponsoring raffles to attract consumers to the booth, these strategies often do not sufficiently drive consumers towards the booth. Thus, a need exists for a method to draw consumers to information regarding smaller entities whose particular location is an aspect of the business.

In light of the foregoing, it is apparent that smaller entities, which need to drive consumers to a particular location, need additional methods to cooperate with other entities to market their particular businesses. Such a method would provide additional avenues for entities to group and market their products, ideas and/or services without incurring large expenditures relating to pricing, promotion and distribution networks. The present invention provides such a method. Importantly, while the methods of the present invention can be especially beneficial to small entities whose location is a key aspect of the product, idea and/or service it offers, it is to be understood that the methods of the present invention can be employed to enhance marketing, promotion and sales by any entity, large or small, for profit or nonprofit alike.

### SUMMARY OF THE INVENTION

The present invention provides efficient and cost-effective methods for entities to promote themselves through the sale of popular items. In one particular aspect, the present invention provides methods for small or nonprofit entities to promote themselves through the sale of popular items. In another particular aspect, the present invention provides methods for smaller entities whose location is a key aspect of the entity's endeavor or business to advertise and draw consumers to the location of the entity's offerings. The systems and methods of the present invention drive consumers to the location of a smaller entity's offerings more effectively than pure advertising because consumers other than those specifically looking for information regarding the entity (such as a traveler looking for a hotel) will view the information. The methods of the present invention encourage consumers not necessarily looking for particular information to view information regarding various entities that come together to sell popular items at a common location.

In one embodiment of the methods of the present invention, the method comprises creating a directory of entities; promoting the entities in the directory by offering items for sale, wherein each item for sale is marked with an identifier representing an entity in the directory, and providing information about an entity in the directory when a consumer expresses interest in an item marked with an entity's particular identifier. In another embodiment of the methods of the present invention, the entity engaged in creating the directory, and promoting the entities within the directory by offering items for sale and providing information is not an entity in the directory.

In another embodiment of the methods of the present invention, the items for sale are apparel. In another embodiment of the methods of the present invention, the apparel can be undergarments, shirts, sweatshirts, fleeces, sweaters, shorts, pants, socks, shoes, hats, baseball caps, purses, bags, and belts. In another embodiment of the methods of the present invention, the shirts can be t-shirts, collared shirts, button-down shirts, sleeveless shirts, and turtleneck shirts.

In another embodiment of the methods of the present invention, the items for sale can be office related supplies selected from the group consisting of tablets, pens, pencils, notebooks, mugs, coasters, staplers, briefcases and tote bags.

In another embodiment of the methods of the present invention, the items are sports related equipment selected from the group consisting of balls, bats, racquets, water bottles, swim caps, and goggles.

In another embodiment of the methods of the present invention, the entities in the directory are included in the directory based on the payment of a fee.

In another embodiment of the methods of the present invention, the entities in the directory are selected from the group consisting of businesses, for profit or nonprofit organizations, churches, teams, schools and academic institutions. In another embodiment of the methods of the present invention, the entities in the directory are destination businesses. In another embodiment of the methods of the present invention, the destination businesses are privately-owned businesses.

In another embodiment of the methods of the present invention, the entity engaged in the creating, promoting, offering and providing further provides information to each of the entities in the directory regarding interest in or sales of items marked with the particular entity's identifier.

In another embodiment of the methods of the present invention, the entity engaged in the creating, promoting, offering and providing collects money based on the sale of the items. In another embodiment of the methods of the present invention, the entity engaged in the creating, promoting, offering and providing further makes payments to the entities in the directory based on sales of items marked with the particular entity's identifier.

In another embodiment of the methods of the present invention, the offering and providing occurs at a retail store. In another embodiment of the methods of the present invention, when the offering and providing occurs at a retail store, the providing of the information is in the form of a tag or brochure attached to the item offered for sale.

In another embodiment of the methods of the present invention, the offering and providing occurs over the internet.

In another embodiment of the methods of the present invention, the providing further includes making a coupon available to consumers who express interest in items marked with an entity's particular identifier. In another embodiment of the methods of the present invention, the coupons provide a discount for the products, ideas and/or services offered by the entity associated with the identifier in which a particular consumer has expressed interest. In another embodiment of the methods of the present invention, in order to receive a coupon for the products, ideas and/or services offered by an entity, the consumer must purchase an item marked with an identifier of the entity. In another embodiment of the methods of the present invention, the coupons of the present invention are made available as printable web pages once a consumer has purchased an item. In another embodiment of the methods of the present invention, the coupons are provided by an employee of a retail store once a consumer has completed a purchase at the retail store. In another embodiment of the methods of the present invention, the provided information includes the fact that consumers will receive one or more coupons if they purchase items marked with an identifier.

### BRIEF DESCRIPTION OF THE FIGURES

FIG. 1A provides a depiction of a screen shot of popular items offered for sale over the internet in accordance with the present invention.

FIG. 1B provides a depiction of a screen shot of information provided about an entity in the directory when a consumer has expressed interest in an item containing that entity's identifier over the internet.

FIG. 2 provides a depiction of the presentation of information about entities in the directory on items offered for sale in a retail store.

### DETAILED DESCRIPTION OF THE INVENTION

Some terms that are used herein are described as follows:

The terms “entity” or “entities” mean one or more individuals that come together for a defined purpose. Non-limiting examples of entities include businesses, for profit or nonprofit organizations, churches, teams, schools, and academic institutions.

The term “directory” means a group of individual entities that one entity chooses to promote. In one embodiment, entities can be included in the directory based on the payment of a fee. In another embodiment, the entity creating the directory can restrict entrance into the directory by only accepting entities with characteristics that the entity creating the directory deems desirable. For example, in one embodiment, the entity creating the directory may require that entities included within the directory be of a certain size (minimum or maximum based on chosen parameters such as number of employees, yearly revenue, number of locations, etc.). In another embodiment, the entity creating the directory may require that the entities included within the directory be privately-owned. In another embodiment, the entity creating the directory may require that the entities within the directory be environmentally-friendly. In another embodiment, the entity creating the directory may require that the entities within the directory be destination businesses. The entity creating the directory can impose any restrictions it chooses on admitting entities into a directory that it creates.

The term “identifier” means a marking that can be placed on an item for sale that consumers do link or can link with a particular entity. Non-limiting examples of identifiers include entity logos, trademarks and/or names.

The phrase “express interest” means that a consumer pays particular attention to an item offered for sale with a particular identifier. For example, if an entity offers items for sale and provides information over the internet, expressing interest in a particular item or entity can occur through clicking on a link related to a particular item or entity. If an entity offers items for sale and provides information in a retail store, expressing interest may be approaching a particular item and/or examining it more closely.

The phrases “destination entities” or “destination businesses” mean an entity whose particular location provides some aspect or feature of the entity's defined purpose. For example, a destination business can be a dine-in restaurant. In one embodiment, the dine-in restaurant has a particular atmosphere or ambience. Other non-limiting examples of destination businesses include hotels, museums, theatres, tourist destinations controlled by one or more entities, concert venues, gyms and spas. In general, what these entities share is that the whole of what they offer is generally not experienced without visiting a particular location.

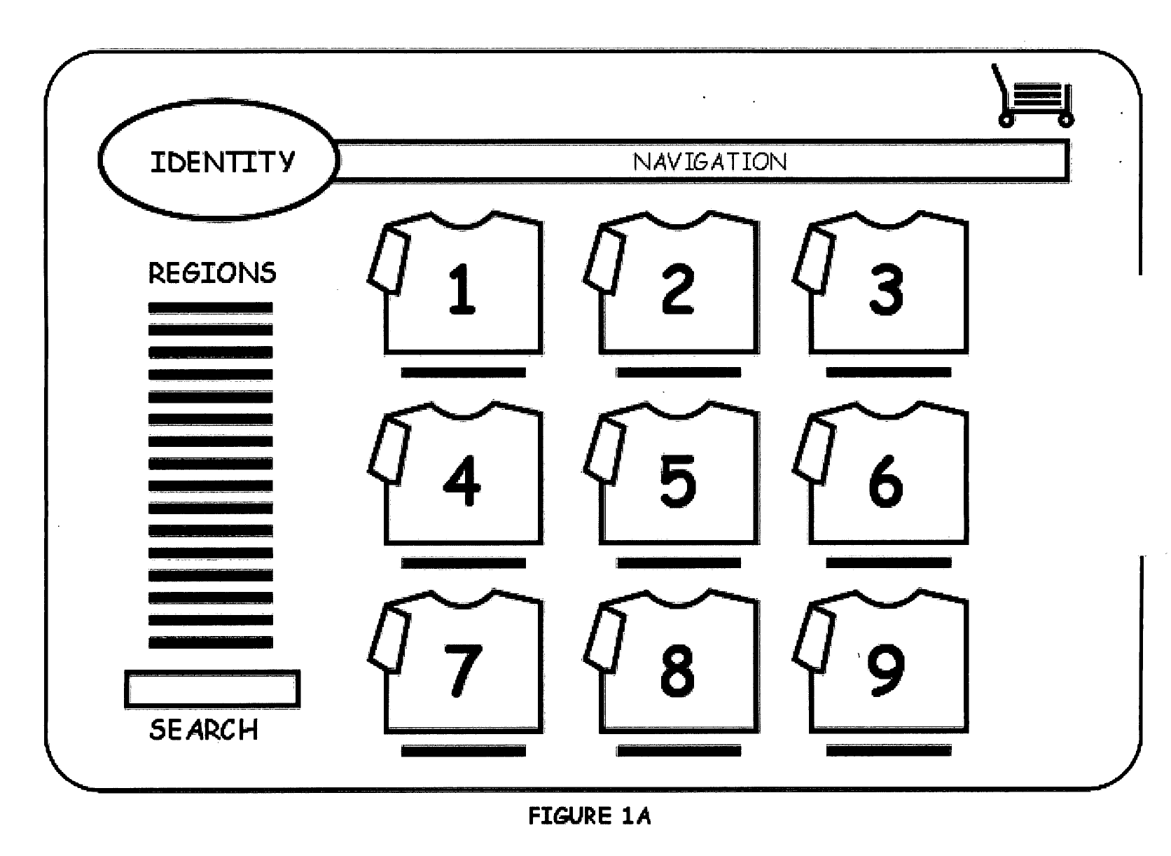

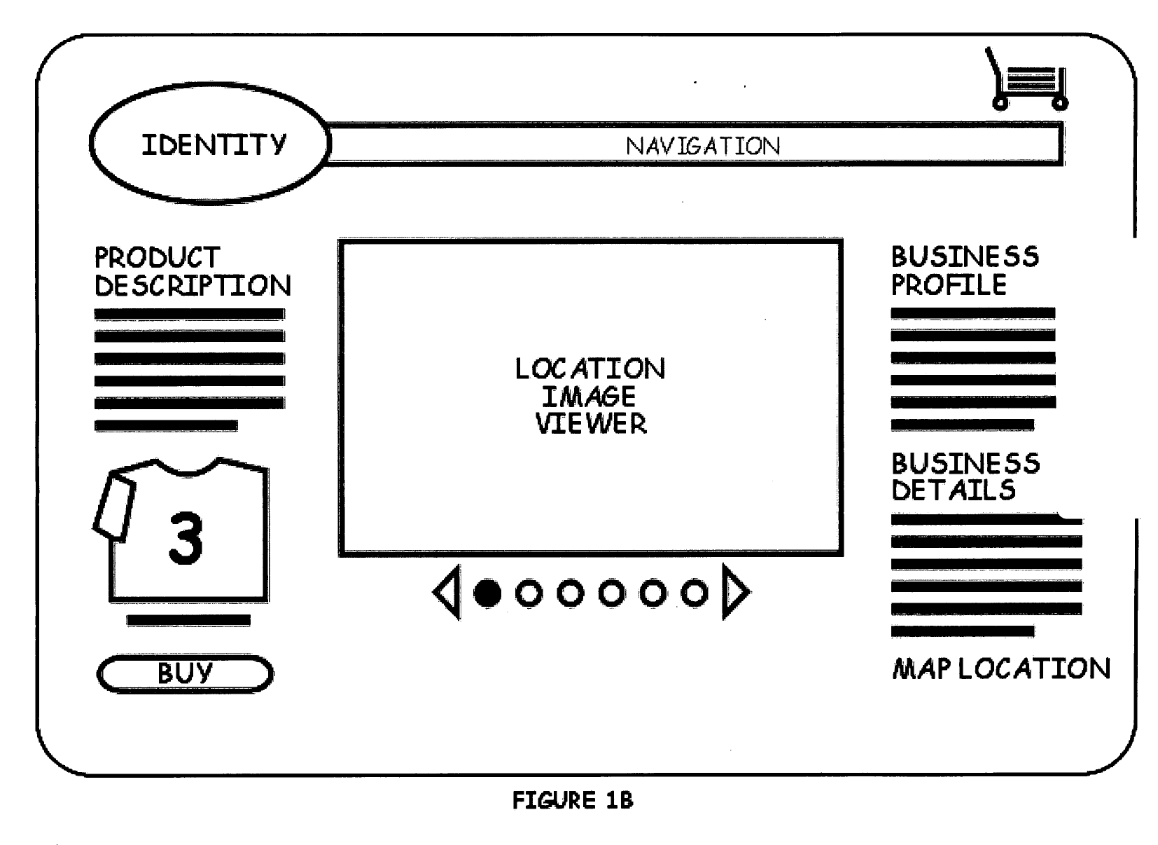

Referring to the FIGS., FIG. 1A depicts a potential web page using the methods of the present invention. In this depicted embodiment, the web page offers t-shirts for sale. While this FIG. 1A depicts t-shirts as an item for sale, embodiments of the methods of the present invention can offer other items or other combinations of items for sale. Each t-shirt depicted in FIG. 1A has the identifier of a different entity that is a member of a directory, and in the particular embodiment depicted by FIGS. 1A and 1B, the entities are businesses. In this depicted embodiment, various identifiers are represented by numbers 1-9. The numbers 1-9 are not meant to represent actual identifiers, but instead are used to indicate that each depicted item for sale has a different identifier. If a consumer is interested in buying a particular t-shirt, the consumer can click on the image of the t-shirt. Clicking on the image of a particular t-shirt brings the consumer to a second web page (an example of which is depicted in FIG. 1B). The second web page provides information about the entity whose identifier appears on the desired t-shirt. At this page, the consumer not only learns information about the entity, but also may purchase the t-shirt. Methods to purchase products over the internet are well known to those of ordinary skill in the art. Thus, they are not presently described in detail.

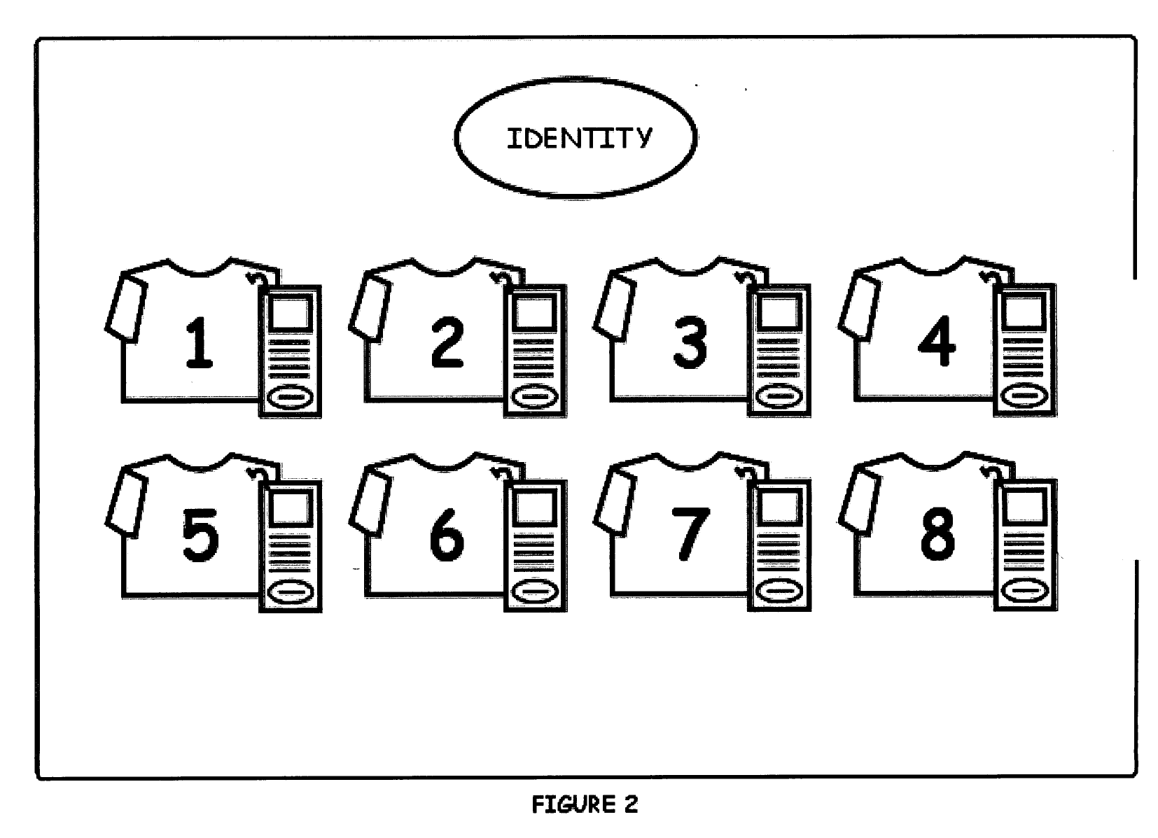

FIG. 2 depicts how information regarding an entity associated with a particular identifier on a popular item for sale can be presented in a retail store. In FIG. 2, again depicting the sale of t-shirts, the t-shirts are presented as mounted onto a wall or rack. Tags or brochures providing information about the entity associated with a particular t-shirt's identifier are attached to the t-shirts offered for sale. As a consumer approaches a particular t-shirt, the consumer views not only the t-shirt, but also information about the entity associated with the identifier on the t-shirt.

The information provided about a particular entity associated with an identifier can vary according to the type of entity it is. For instance, if the entity is a restaurant, the information provided could include, without limitation, a description of the restaurant's atmosphere or ambience, reviews written about the restaurant, its hours of operation, and a menu. If the entity is a bar, the information provided could include, without limitation, a description of the bar's atmosphere or ambience, reviews written about the bar, its hours of operation, food availability, drink specials and whether the bar allows smoking or not. If the entity is a spa, the information provided could include, without limitation, a list of prices for various treatments, location(s) and customer testimonials. If the entity is a sports team, the information provided could include, without limitation, the team's record over one or more seasons, the team's game schedule, a list of players and positions with individual statistics and sponsors of the team. If the entity is a university, the information provided could include, without limitation, degrees offered, student organizations, tuition costs, class schedules and sports teams. Other types of information that can be provided include, without limitation, particular entity's addresses, phone numbers, email addresses, maps or driving directions to the entity's location or a link to the entity's own web site. Coupons to encourage consumers to patronize entities associated with the identifier also may be presented. If these coupons are presented over the internet, the viewer may print out one or more coupons. In one embodiment, such coupon print outs may only be available if the viewer purchases an item associated with the entity's identifier. If the coupons are presented in a retail store, the coupons may be part of the tag or brochure attached to the item for sale or may be provided as a second attachment. Alternatively, coupons may be given at the cash register when a consumer purchases an item marked with a particular identifier. In presenting information regarding the entities in its directory, the entity creating the directory can decide what information to present or the entity creating the directory can allow the entities included within the directory to decide what information to present.

The methods of the present invention can provide numerous benefits for the entities included in a directory. First, the methods of the present invention provide aggregate marketing power to entities that might not otherwise engage in such marketing. On a general level, this marketing can provide an additional avenue to generate revenue based on the sale of items marked with a particular entity's identifier. The methods of the present invention also provide an avenue to disseminate information about an entity to individuals who are not necessarily seeking information regarding a product, idea and/or service offered by one or more entities within a directory. The methods of the present invention also provide avenues for entities within a directory to collect information regarding interest in their identifier and offerings based on the number of identifier hits and/or sales on an internet site and/or the number of sales of items marked with their identifier in a retail store. In one embodiment, consumers buying items marked with particular identifiers can be asked to provide personal information that can be sent to the entity associated with the particular item and identifier's sale.

It is to be understood that the present invention is not limited to the particular embodiments, materials, and examples described herein, as these can vary. It also is to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an item” or “a directory” is a reference to one or more items or directories and includes equivalents thereof known to those skilled in the art and so forth.

Unless defined otherwise, all technical terms used herein have the same meanings as commonly understood by one of ordinary skill in the art to which this invention belongs. Specific methods, devices, and materials are described, although any methods and materials similar or equivalent to those described herein can be used in the practice or testing of the present invention.

What is claimed is:

1. A method comprising
creating a directory of entities;
promoting said entities in said directory by
offering items for sale, wherein each item for sale is marked with a identifier of an entity in said directory, and
providing information about an entity in said directory when a consumer expresses interest in said item marked with said entity's particular identifier.

2. The method of claim 1, wherein said directory is created by an entity that is not an entity within said directory.

3. The method of claim 1, wherein said items are apparel selected from the group consisting of undergarments, t-shirts, collared shirts, button-down shirts, sleeveless shirts, turtleneck shirts, sweatshirts, fleeces, sweaters, shorts, pants, socks, shoes, hats, baseball caps, purses, bags, and belts.

4. The method of claim 1, wherein said items are office or sports related supplies selected from the group consisting of tablets, pens, pencils, notebooks, mugs, coasters, staplers, briefcases, balls, bats, racquets, water bottles, swim caps, and goggles.

5. The method of claim 1, wherein said entities in said directory are included in said directory based on payment of a fee.

6. The method of claim 1, wherein said entities in said directory are selected from the group consisting of businesses, for profit or nonprofit organizations, churches, teams, schools and academic institutions.

7. The method of claim 1, wherein said entities in said directory are destination businesses.

8. The method of claim 7, wherein said destination businesses are privately-owned businesses.

9. The method of claim 1, wherein said entity engaged in said creating, promoting, offering and providing further provides information to each of said entities in said directory regarding sales of items marked with said particular entity's identifier.

10. The method of claim 1, wherein said entity engaged in said creating, promoting, offering and providing collects money based on said sale of said items.

11. The method of claim 10, wherein said entity engaged in said creating, promoting, offering and providing further makes payments to said entities in said directory based on sales of items marked with a particular entity's identifier.

12. The method of claim 1, wherein said offering and providing occurs at a retail store.

13. The method of claim 12 wherein said providing of said information is in the form of a brochure or tag attached to the item for sale bearing a particular entity's identifier.

14. The method of claim 1, wherein said offering and providing occurs over the internet.

15. The method of claim 1, wherein said providing further includes making a coupon available to said consumer who has expressed interest in an item marked with a particular entity's identifier.

16. The method of claim 15, wherein said coupon provides a discount for the products, ideas and/or services offered by the entity associated with the identifier in which said consumer has expressed interest.

17. The method of claim 1, wherein if said consumer purchases an item marked with an identifier, said consumer receives a coupon for a discount for the products, ideas and/or services offered by the entity associated with said identifier on said purchased item.

18. The method of claim 17, wherein said coupon is made available as a printable web page once said consumer has purchased said item.

19. The method of claim 17, wherein said coupon is provided by an employee of a retail store once said consumer has completed said purchase at said retail store.

20. The method of claim 17, wherein said provided information includes the fact that said consumer can receive said coupon if said consumer purchases said item.
